(19) United States
(12) Patent Application Publication
(10) Pub. No.: US 2008/0229225 A1
(43) Pub. Date: Sep. 18, 2008

(54) Method for Displaying Search Results for Items with Geographic Attributes

(76) Inventor: Evan J. Kaye, Short Hills, NJ (US)

Correspondence Address: EVAN J. KAYE, 330 White Oak Ridge Rd, Short Hills, NJ, 07078, US

(21) Appl. No.: 11/847,827

(22) Filed: Aug. 30, 2007

Related U.S. Application Data
(60) Provisional application No. 60/824,194, filed on Aug. 31, 2006.

(51) Int. Cl. G06F 17/30; G06F 3/048; G06F 7/06

(52) U.S. Cl. 715/771; 707/5; 707/E17.014

(57) ABSTRACT

A method for superimposing items on a map in an aggregated manner by the use of multicolored symbols, and thereby preventing overlap. The method provides a mechanism for a user to appreciate the price distribution of items represented by the symbol by means of a dynamic control that can be changed on the display by the user while watching the appearance of the symbols.

### RELATED U.S. APPLICATION DATA

This is the non-provisional application of provisional application No. 60/824194, filed on Aug. 31, 2006.

### FIELD OF THE INVENTION

The present invention relates to a way to improve an online shopper's experience by representing the price distributions of items as symbols on a map of geographical relevance to the items.

### BACKGROUND OF THE INVENTION

Searches for products and services on the Internet is commonplace nowadays, and oftentimes the items in the search results contain geographical attributes which can be plotted out on a map. Many online search engines offer such a service, where a “local search” can be done, and the search results will be displayed in conventional list form, as well as being depicted by “flags” on a map. For example, searching for hotels in an area, or searching for seat tickets at a concert. A problem with this method is that it is common for the flags to overlap, and make it difficult for the user to appreciate the exact location. When this happens, a user needs to enlarge an area of interest by zooming in, which can be a cumbersome and less satisfactory user experience.

Some websites try to alleviate these problems by summarizing information at a particular zoom level, by depicting a price range in a specific geographic area on the map. The problem with this is that the price range is oftentimes static, and not relevant to the user (for example, a particular concert hall section might be colored a specific color on a spectrum of blue to red to represent the average or lowest priced seat that is available in the section. The problem with this solution is that it is still difficult for the user to discern which sections fall into their price range.

Another solution that has been tried is to allow the user to select their price range either before displaying the results or when the results are displayed, and make visible only those results that fall within the user's price range. A problem with this method is that the user cannot see the items that fall slightly outside their price range, but might be a better deal than their exact price range. Furthermore, it necessitates the user to decide how much they are willing to spend before seeing the full spectrum of options.

Another problem is that for live events, current solutions only offer search results on geographically relevant maps for a single event at a single time for a particular venue. What is more useful to a user, is the ability to display the search results for multiple events (of the same type or different types) on the same map. By doing this, the user need not evaluate each event date (for example, for a theater performance) individually, but can view the aggregate search results from all dates that they are available on one map.

A further problem, that is related to evaluating which date is preferred to attend a particular event, is that users currently have their schedule in a different place to where they view their search results. What is needed is a way to flag search results that have a time attribute with schedule conflict information, so that a user can make an educated choice about which events they can attend, without having to consult their calendar separately.

### SUMMARY OF THE INVENTION

In one aspect of the invention, an interactive geographic map is displayed as part of search results for a product or service containing geographic and pricing attributes. When viewing a large geographic area where the precise locations of the items are not extremely relevant to the purchase decision, composite symbols are used to represent the number of items matching in the vicinity of the symbol, as well as color coding the symbol to represent the number of matches that are within the user's price range vs. above the user's price range. In this way, a user can dynamically alter their price range and monitor how the symbols change. Starting from a low price range, and moving their price range upwards, a user watches for a symbol that is in the best position for any given price range they have selected, or in a location that is satisfactory to them. The price range should be easily altered by means of an interactive tool, such as a slider. At any time, a user can click on the symbol, and view details of the items comprising the representation on that symbol.

In a related aspect of the invention where geographic location, and price (for example, hotels) are not the only important attributes, but also time (for example, live sporting events) is a further attribute, a user can first generate a list of events matching certain search criteria. For example, all events at Yankee stadium where the Red Sox team is playing, can be used. A user can then select only those events (for example, on Fri and Sat) that they are interested in attending. By doing this, only tickets available for those specific events will be shown in aggregate on the interactive search results. By selecting multiple events in this way, a user need not evaluate the offers for each event individually.

In another aspect of the invention, a user can have the search service connect to their electronic calendar (that is hosted either locally or through an online service) and indicate to the user in the event search results which events conflict with an existing item on their calendar, so that the user is aware of the conflict and does not select that event as a potential event.

### DESCRIPTION OF THE FIGURES

FIG. 1 illustrates a network arrangement of hardware and software for implementing a method in accordance with a preferred embodiment of the invention;

FIG. 2 shows an exemplary search form for searching for desired event tickets in accordance with the preferred embodiment of the invention;

FIG. 3 shows an exemplary selection form for selecting desired events in accordance with the preferred embodiment of the invention;

FIG. 4 shows an exemplary login form for accessing remote calendar information in accordance with the preferred embodiment of the invention;

FIG. 5 shows an exemplary selection form (with scheduling conflict alerts) for selecting desired events in accordance with the preferred embodiment of the invention;

FIG. 6 shows an exemplary graphically interactive selection form for selecting desired ticket offers in accordance with the preferred embodiment of the invention;

FIG. 7 shows an exemplary selection form for reviewing and selecting tickets among a group of user defined ‘Favorites’;

FIG. 8 shows an email for sending selections or ‘Favorites’ to another user via electronic mail;

FIGS. 9A and 9B illustrate a process flow by which a user searches for and selects tickets for events in accordance with the inventive method.

### DETAILED DESCRIPTION OF THE PREFERRED EMBODIMENT

By way of overview and introduction, a method in accordance with a preferred embodiment of the invention provides a multi-step process for a user to search and select desired event tickets at a venue, ultimately leading to the purchase of those tickets. First, the user is presented with a web page form comprising an input field and a search button. The user enters a search phrase/keyword and begins a search upon submitting the form. Users may also initiate a search by clicking on one of the link options displayed above the form. Second, the matching results are retrieved from the ticket search website database and displayed alphabetically according to venue in tabular form. The user may then select one or more events at a venue and the number of tickets desired. Third, the user is presented with a new page displaying the venue map and seat information. The user may find tickets by adjusting a price range and by clicking on the venue map. When the user is satisfied, the user may then click the Buy Now button to be transferred to a ticket seller's site.

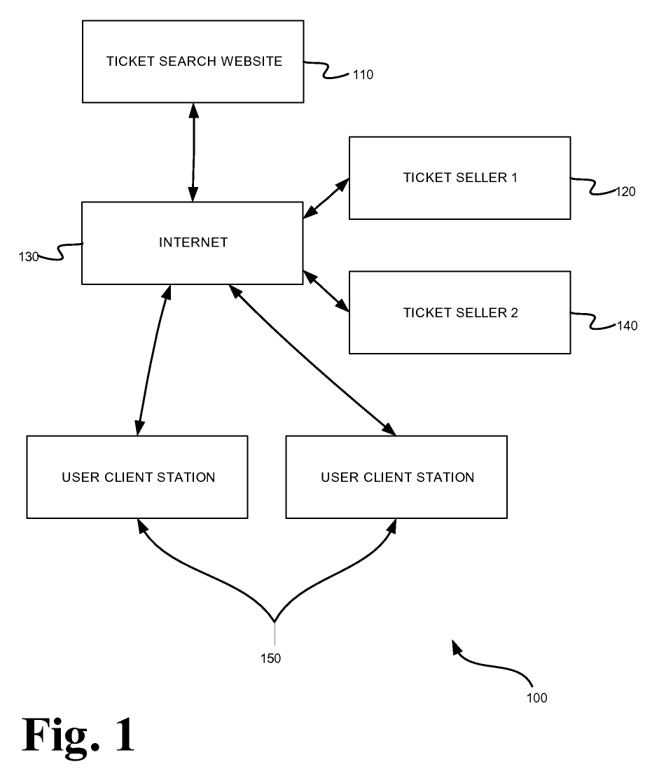

With reference now to FIG. 1, a network arrangement of hardware components for implementing a method in accordance with the present invention is described. The network 100 includes a Ticket Search Site 110 which provides content over the Internet 130 to a plurality of distributed users that access the ticket search site 110 through user client stations 150. The content provided by the ticket search site 110 can be viewed by users through a World Wide Web browser or other functionally equivalent software running at their respective user client stations 150. The user client stations 150 can assume a variety of forms, including a home computer, a cellular phone, a PDA, an Internet compliant telephone, or other Internet compliant communications device.

The ticket search site 110 communicates with a plurality of ticket sellers, represented here by Ticket Seller 1 120 and Ticket Seller 2 140, to retrieve and synthesize ticket availability data. Ticket Seller 1 120 and Ticket Seller 2 140 make their lists of purchasable tickets available to Ticket Search Site 110 via the Internet 130 through public websites that Ticket Search Site 110 can crawl the way search engines typically operate, through web services, through syndication (e.g. RSS), or through other electronic means as known by those of skill in the art. Through the use of the Ticket Search Site 110 users can access and search through ticket offerings aggregated from a variety of sources.

The Ticket Search Site 110, Ticket Seller 1 120 and Ticket Seller 2 140, and plural user client stations 150 are configured to communicate with one another in a conventional manner over communication link through the Internet 130. In lieu of the Internet, communications can be through an Intranet or Extranet, as understood by those of skill in the art.

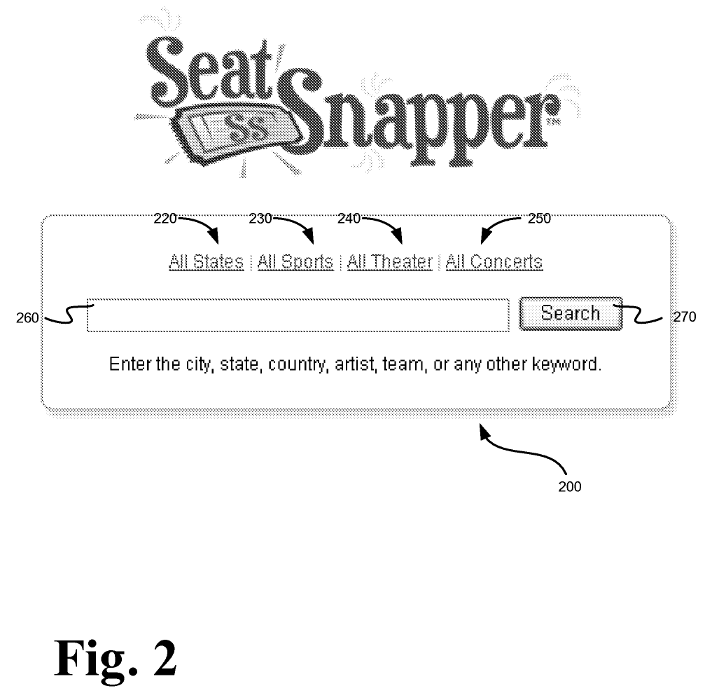

FIG. 2 shows an exemplary search form 200 used to search for desired event tickets in accordance with the preferred embodiment of the invention. The search form 200 is generated on the ticket search site 110 and can be implemented as an HTML file having form tags, or as an ActiveX, JavaScript, DHTML, Flash or other component that executes on the client station, as understood by those of skill in the art.

The selection form 200 comprises two parts: (1) an input field 260 and a search button 270, and (2) ‘quick search’ link options allowing the user to view all events belonging to a particular category or type. These ‘quick search’ options are made available as website links, being All States 220, All Sports 230, All Theater 240, and All Concerts 250 links respectively. The user selects the search button 270 to submit the form to the Ticket Search Site 110 in FIG. 1.

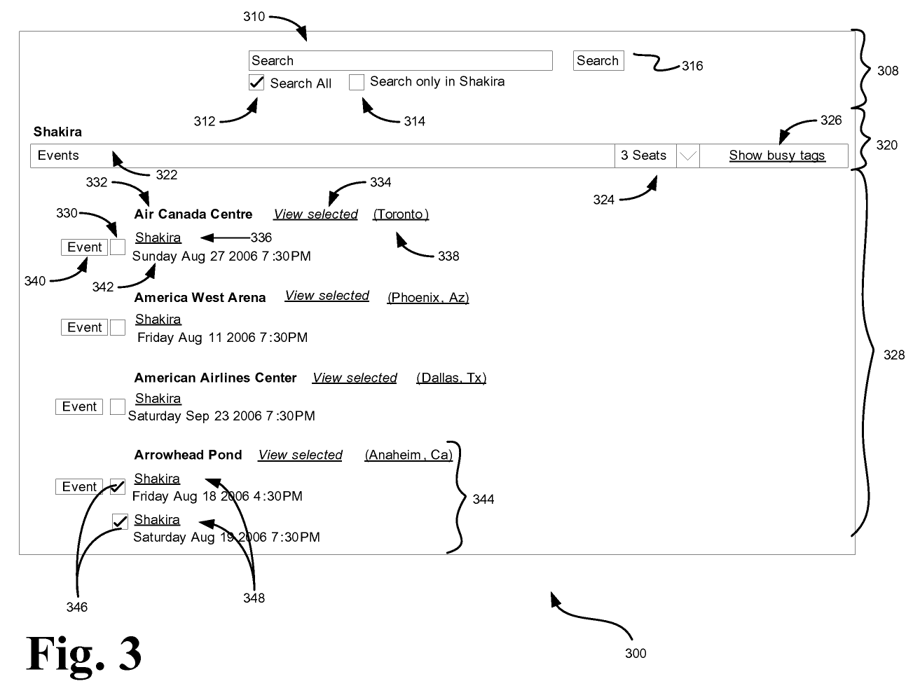

FIG. 3 shows an exemplary selection form 300 for selecting desired events in accordance with the preferred embodiment of the invention. The selection form 300 is a response from the server when the user submits form 200 of FIG. 2, and is divided into three regions: a header region 308, a modification panel 320, and a selection region 328. The header region 308 includes a search form comprising an input field 310 and two radio buttons which allow the user to search the entire ticket network site, by selecting the Search All radio button 312 or to search within the search results of the previous search term, by selecting the Search Only In 314 radio-button before clicking the search button 316.

Below the header region 308, the modification panel 320 comprises a Title 322 and tools for manipulating the search results. These tools include a drop-down menu box 324 which enables the user to select the desired quantity of seats and a Show Busy Tags link 326 which allows the user to interface with client-based or remotely stored calendar information (for example, Google Calendar) to determine which events conflict with appointments conflict with events displayed in the search results.

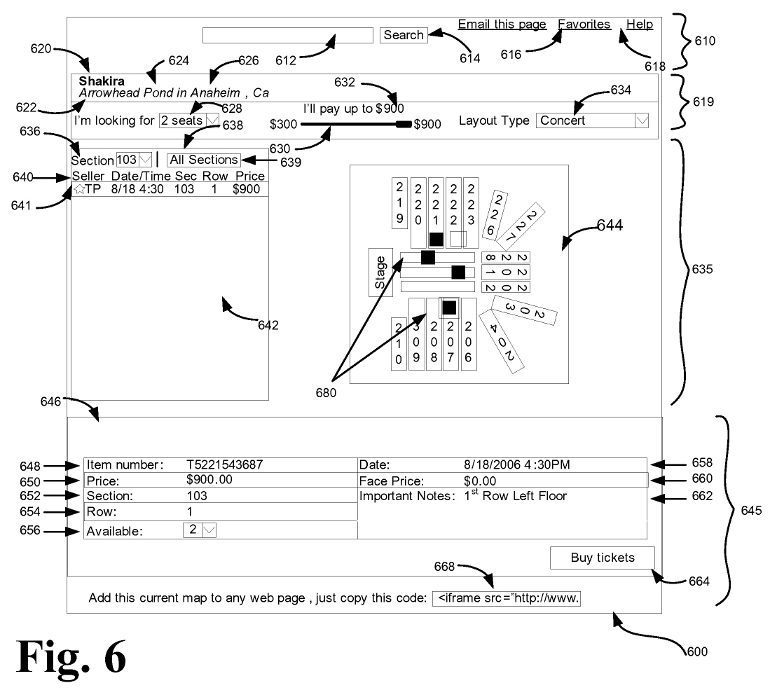

The selection region 328 is below the modification panel 320 and displays those venues which contain matching events. Matching events are designated by an Event Tag 340 and are displayed under their respective venues in a set format which contains the Venue Name 332, the Venue City 338, the Event Name 336, and the Event Date/Time 342. The user may select an event by placing a check in the check-box 330 adjacent to the Event Name 336 and by then clicking on a View Selected button 334, or alternatively by just clicking the Event Name 336. The method of checking the check-box 330 is especially useful when multiple events need to be selected by the use. To illustrate this, a venue with multiple events 344 is shown. When a user checks off the check-boxes 346 corresponding to both Event Names 348 respectively, then ticket listings from both events will be shown, in aggregate, on the interactive venue map of FIG. 6, which the user is able to navigate to by clicking the View Selected 334 link. As only one interactive venue map of FIG. 6 can be displayed at a time, those checkboxes 346 adjacent to the multiple events that are selected, would automatically be cleared should a user select a checkbox that does not correspond to the same venue (for example, the checkbox 330 adjacent to the event 336, which corresponds to an event at Air Canada Centre 332). The user may also click on the Venue Name 332 to select every check-box 330 next to each of the Venue Name's Event Names 336. There is also a Venue City link 338 that indicates to the user where the respective venue is located, and the user can click it to link to a page that displays all events in that city.

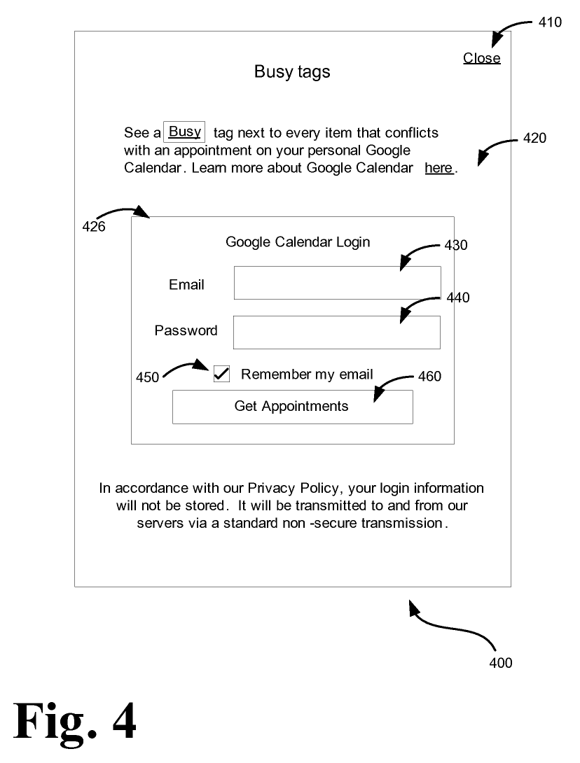

FIG. 4 shows the Busy Tags window 400 that appears when the user clicks the busy tag option 326 of FIG. 3. Contained within this window is a link to close the window 410, a link to learn more about Google Calendar 420, and a Google Calendar login form 426. The Google Calendar login form 426 contains an email address field 430, a password field 440, a check box to allow the application to ‘remember’ the user's email address 450 (as commonly done by those with skill in the art via a the placement of a client-based cookie), and a Get Appointments button 460. When a user fills in the login form 426 and clicks the Get Appointments button 460, the login information is transmitted to the website server, and in turn a query is made to the remote data source along with the user-supplied login information. The remote data source then replies to the website server with calendar appointment information specific to the account that matches the login credentials supplied by the user.

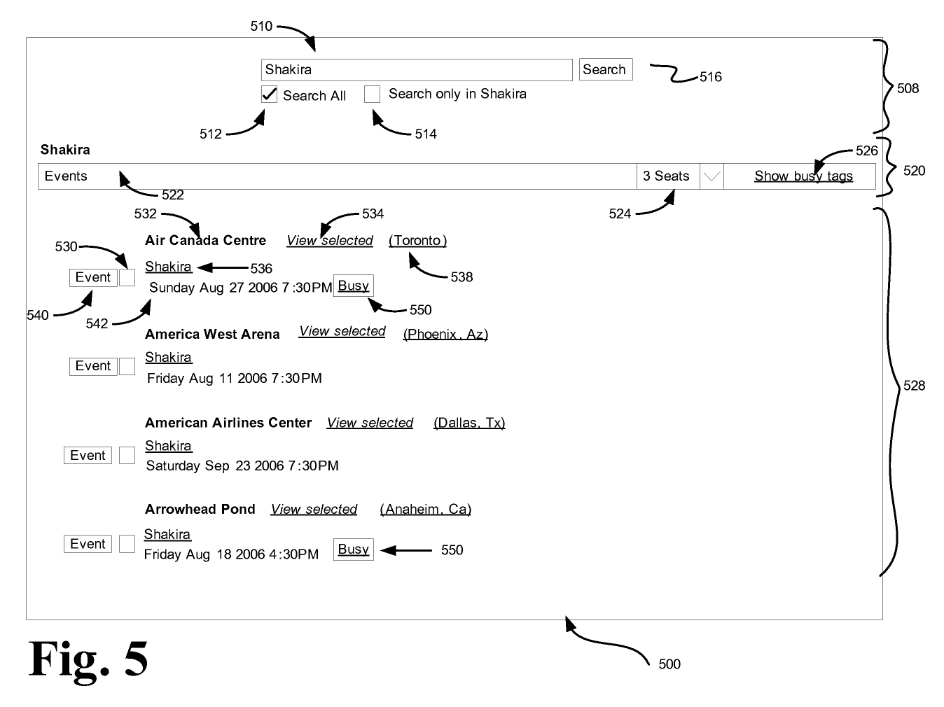

FIG. 5 shows an exemplary selection form 500 for selecting desired venue events in accordance with the preferred embodiment of the invention, and is essentially the same as form 300 of FIG. 3, but differs in that it contains Busy Tags 550 indicating to the user which events in the search results conflict with existing appointments on their calendar. The selection form 500 is divided into three region types: a header region 508, a modification panel 520, and a selection region 528. The header region 508 includes a search form comprising an input field 510 and two radio buttons which allow the user to search the entire ticket network site, by selecting the Search All radio button 512 or to search within the search results of the previous search term, by selecting the Search Only In 514 radio-button before clicking the search button 516. Below the header region 508, the modification panel 520 comprises a Title 522 and tools for manipulating the search results. These tools include a drop-down menu box 524 which enables the user to select the desired quantity of seats and a Show Busy Tags link 526 which allows the user to interface with client-based or remotely stored calendar information (for example, Google Calendar) to determine which events conflict with appointments conflict with events displayed in the search results. The selection region 528 is below the modification panel 520 and displays those venues which contain matching events. Matching events are designated by an Event Tag 540 and are displayed within their respective venues in a set format which contains the Venue Name 532, the Venue City 538, the Event Name 536, and the Event Date/Time 542. The user may select an event by clicking the check-box 530 adjacent to the Event Name 536 and by then clicking on a View Selected button 534. There is also illustrated a venue with multiple events 544. When a user clicks the check-boxes 546 corresponding to both Event Names 548 respectively, then ticket listings from both events will be shown, in aggregate, on the interactive venue map of FIG. 6. The user may also click on the Venue Name 532 to select every check-box 530 next to each of the Venue Name's Event Names 536. There is also a Venue City link 538 that indicates to the user where the respective venue is located, and the user can click it to search for all events in that city. The selection form contains Busy Tags 550, which are displayed adjacent to Events that conflict with the user's schedule according to calendar information retrieved from an electronic calendar. The Busy Tags 550 are for informational purposes only to the user, and do not hinder the user from selecting any desired option. If a user holds their mouse over one of the Busy Tags 550, then details of the appointment on their calendar appear as a tooltip.

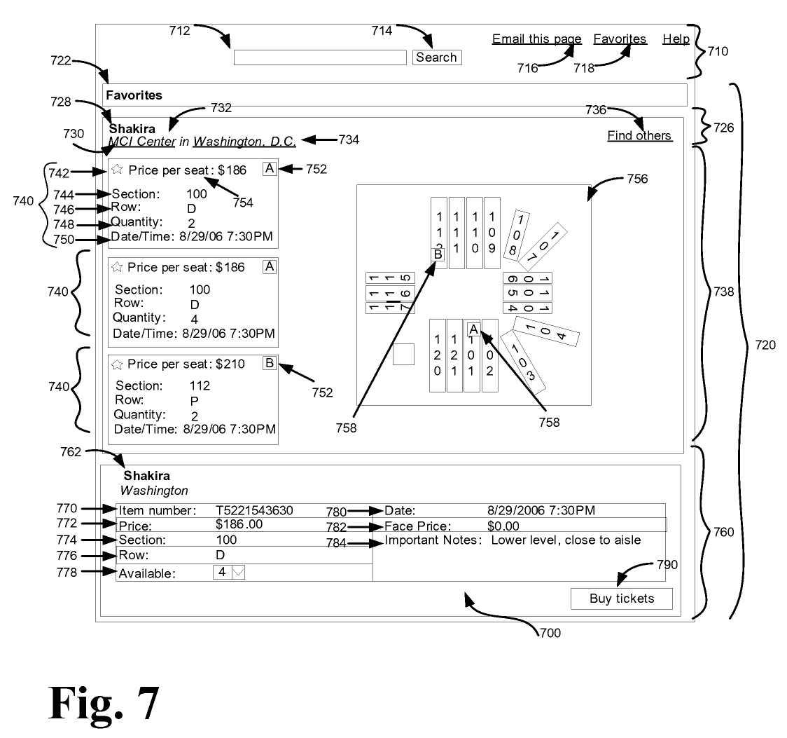

FIG. 6 shows an exemplary graphically interactive selection form 600 for selecting desired ticket groups in accordance with the preferred embodiment of the invention. The selection form 600 is divided primarily into four regions: a header region 610, a modification panel 619, a selection region 635, and an information panel 645. The header region 610 includes a search form comprising an input field 612 and a search button 614. This enables the user to search the entire site upon entering a keyword or search phrase. The header region also contains two links; the Email This Page link 616 enables the user to email the page to another individual and the Favorites link 618 allows the user to view items that they have selected as their ‘Favorites’ as described in more detail with respect to FIG. 7. Below the header region 610, the modification panel 619 comprises a Title 620 which is the name of the Event selected on form 300 of FIG. 3, but may instead be the name of the Venue if different Event Names are represented on the page. The Venue Name 622, the Venue City 624, and State Name 626 are represented under the Title 620, when the Title 620 is an Event Name. In addition, there are three tools for manipulating the tickets results displayed. The first tool is a Quantity drop-down menu box 628 which enables the user to select the desired quantity of seats. The second tool is a dynamic slider 632 that the user can drag along a price range continuum 630 by clicking and dragging their mouse to adjust their price range. The third tool is a venue layout type drop-down menu box 634 which allows the user to adjust the venue layout type (eg. Concert, Tennis, Basketball, etc.). The graphical venue map 644 will change accordingly.

The selection region 635 resides below the modification panel 619 and displays a tabular output of tickets 642 that meet the user-defined specifications as set in the modification panel 619 and the Section drop-down menu box 636. The selection region 635 also contains a graphical map of the venue 644, corresponding to the selected layout type as determined from the drop-down menu box 634. Within the ticket display table 642, the listing of tickets 641 for a specific section can be altered via the section drop-down menu box 636. Alternatively, users may click the All Sections button 638 to view the tickets from all sections corresponding to the user-defined specifications set in the modification panel 619. Other options include the ability to add or remove a ticket to ‘Favorites’ by clicking on the star 641 to the left of the ticket. Users may also sort tickets according to price, row, section, and date/time as listed on row 639 of the ticket display table 642.

The graphical map of the venue 644 has symbols 680 displayed on it representing tickets that are available in the region of the venue over which the symbol is displayed. As the price range is adjusted by the dynamic slider 632, the symbols 680 on a graphical map of the venue 644 change dynamically to represent the number of seats available in the user's price range in the region of the graphical map of the venue 644 underlying the symbol. A large symbol represents more seats available, and the proportion of colors in the symbol represents to the user the corresponding proportion of tickets that are available in the user's price range. By clicking on one of the symbols 680 the user can change the selection in the drop down menu box 636 to correspond with the section represented by said symbol 680. This action in turn changes the listing of tickets available on the ticket display table 642 to those that are specific for the selected section.

While the size of the symbols are determined primarily by the number of tickets they represent, an algorithm determines if any of the symbols will overlap each other given their proximity and the size they were primarily determined to be. If so, all symbols are decreased in size proportionally to minimize the overlap. There are maximum and minimum sizes for the symbols that override all aforementioned rules.

Below the selection region 635, the information panel 645 displays detailed information about an item selected in the ticket display table 642, which the user selects by clicking on an individual ticket listing 640. The information provided includes the name and location of the event in the header 646, the item number 648, price 650, section 652, row 654, number of tickets available 656, date and time 658, face price 660, and important notes about the ticket 662. Below this information is a Buy Ticket button 664 which directs users to a ticket seller's website to buy the selected tickets. Also within this panel is the source code necessary to display this page in a frame on another website 668, should the user want to dynamically display ticket availability information for a particular event or number of events, on their own web page.

FIG. 7 shows an exemplary selection form 700 for reviewing and selecting tickets among a group of user defined ‘Favorites’. The selection form 700 is divided primarily into two regions, a header region 710, and a ‘Favorites’ region 720. The header region 710 includes a search form comprising of an input field 712 and a search button 714. This enables the user to search the entire site upon entering a keyword or search phrase. The header region also contains two links; the first enables the user to email the page to another individual 716 and the second link allows the user to view user-defined ‘Favorites’ 718. Below the header region 710, the ‘Favorites’ region comprises a title 722 labeled “Favorites” followed by three other regions: an identity panel 726, a selection region 738, and an information panel 760.

The identity panel comprises a Title 728 which is the name of the Event, but may instead be the name of the Venue if different Event Names are represented on the page. The Venue Name 730, the Venue City 732, and State Name 734 are represented under the Title 728. In addition, there also exists a Find Others link 736 which enables the user to navigate away from the ‘Favorites’ to search for additional tickets.

The selection region 738 is below the identity panel 726 and displays both the ‘Favorite’ tickets 740 previously selected by the user and the corresponding graphical venue map 756. Each ‘Favorite’ ticket 740, has a set format which includes Price per Seat 754, Section 744, Row 746, Quantity 748, and the Date/Time 750. Also represented is an item letter symbol 752 that corresponds to the section labeled with the same venue map letter symbol 758 on the graphical venue map 756. The user may quickly determine the location of the tickets by comparing the item letter symbol 752 to the venue map letter symbol 758 on the graphical venue map 756. In addition, the user may remove a ticket from ‘Favorites by clicking on the star 742 to the left of the ticket.

Below the selection region 738, the information panel 760 displays detailed information about a “Favorite” ticket 740, which the user selects by clicking a specific “Favorite” ticket 740. The information provided includes the name and location of the event in the header 762, the item number 770, price 772, section 774, row 776, number of tickets available 778, date and time 780, and face price 782. Below this information is a Buy Ticket button 790 which directs users to a ticket seller's website to buy the selected tickets.

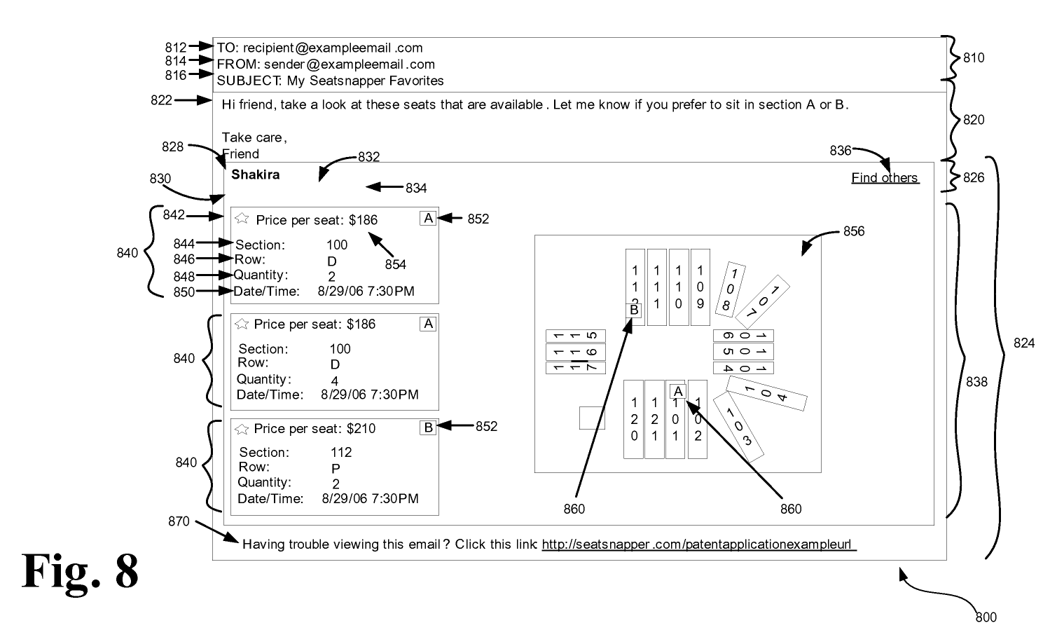

FIG. 8 shows an email 800 for sending selections of ‘Favorites’ to another user via electronic mail. The email 800 is divided primarily into three regions: a header region 810, a message region 820, and a ‘Favorites’ region 824. The header region 810 contains the recipient address 812, the sender address 814, and the subject 816. Below the header region 810, the message region 820 contains a personal message 822 from the user. The ‘Favorites’ region 824 is below the message region 820 and comprises an identity panel 826 and a selection region 838. The identity panel comprises a Title 828 which is the name of the Event, but may instead be the name of the Venue if different Event Names are represented on the page. The Venue Name 830, the Venue City 832, and State Name 834 are represented under the Title 828. In addition, there also exists a Find Others link 836 which enables the user to navigate away from the email 800 to the ticket search site 110 of FIG. 1 to search for additional tickets for that specific event, or venue.

The selection region 838 is below the identity panel 826 and displays both the ‘Favorite’ tickets 840 selected by the sender of the email and the corresponding graphical venue map 856. Each ‘Favorite’ ticket 840, has a set format which includes Price per Seat 854, Section 844, Row 846, Quantity 848, and the Date/Time 850. Also represented is an item letter symbol 852 that corresponds to the section labeled with the same venue map letter symbol 860 on the graphical venue map 856. The user may quickly determine the location of the tickets by comparing the item letter symbol 852 to the venue map letter symbol 860 on the graphical venue map 856. The star 842 to the left of the ticket designate it as belonging to a set of ‘Favorites’. In addition, there is a link 870 which enables the user to navigate to another page on the ticket search site 110 of FIG. 1 if there is difficulty viewing the email 800.

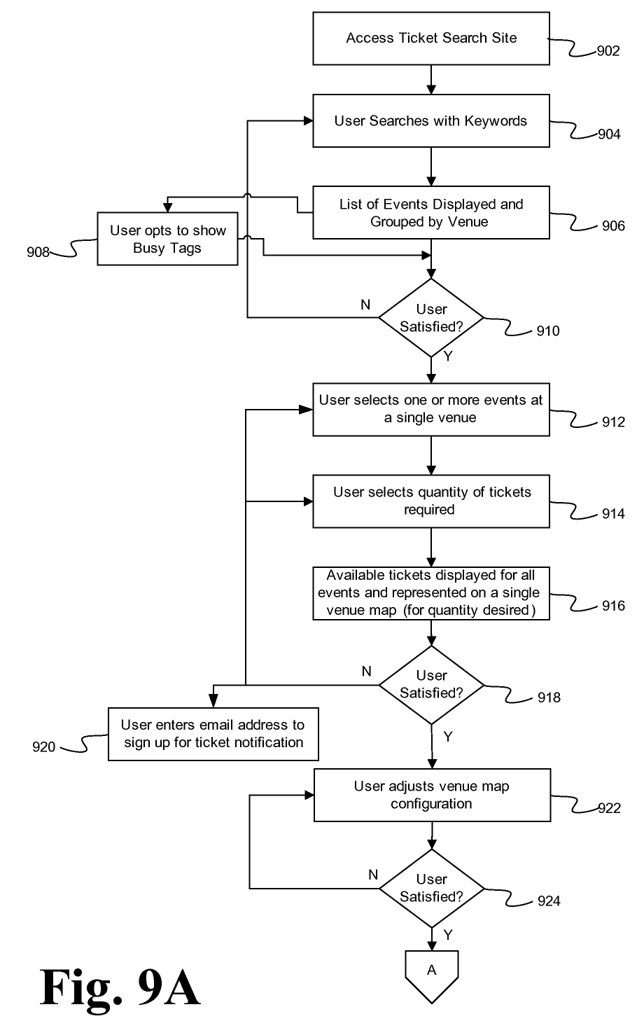

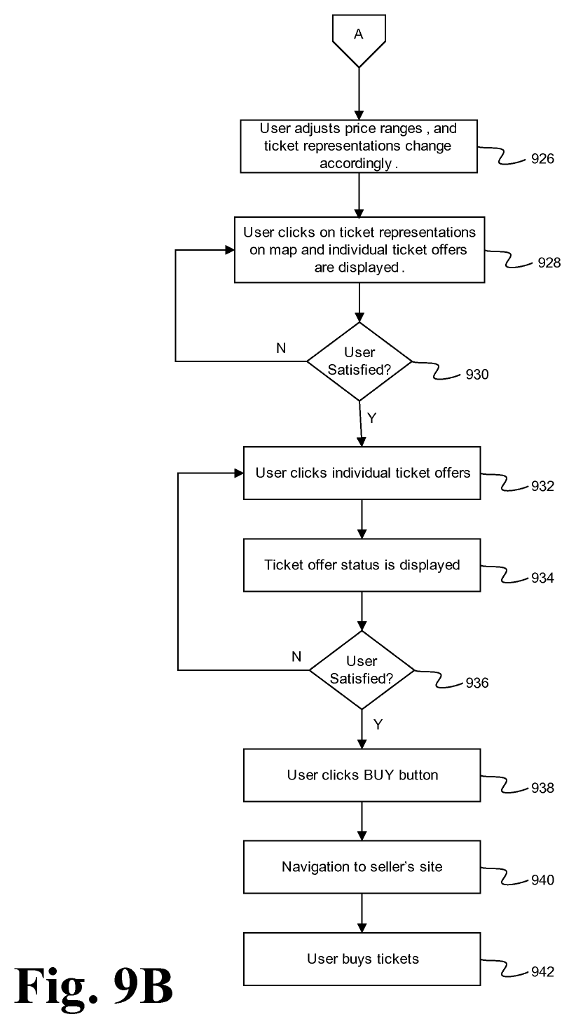

The process flow of FIGS. 9A-B is used to revisit the steps that a user takes at the online ticket search site by way of illustration. At step 902, the user accesses the ticket search site 110 of FIG. 1 from the user client station 150 of FIG. 1. The user then enters keywords and performs a search at step 904 by using the search form 200 of FIG. 2. At step 906, the user views the lists of events as retrieved from the database based on the search. The user may now opt to show busy tags 908 by using the login form 400 of FIG. 4 to access remote calendar information. At step 910, if the user is not satisfied, the user can return to step 904 to perform the search with different keywords. Otherwise, the user proceeds to step 912 and uses form 300 of FIG. 3 to select one or more events at a single venue and then the quantity of tickets required in step 914. At step 916, the available tickets are displayed for all events and represented on a single venue map on form 600 of FIG. 6. If in step 918 the user is not satisfied, the user may return to steps 912 or 914 to adjust the settings or the user may proceed to step 920 to sign up for an email notification so as to be advised when new tickets matching the previously defined specifications have been added. Otherwise, at step 922, the user adjusts the venue layout type to correspond to the type of event desired (eg. Concert, Tennis, Basketball, etc.). If the user is not satisfied at step 924, the user may return to step 922 to readjust the venue map configuration. At step 926, as shown in FIG. 9B, the user adjusts the price ranges and ticket representation change accordingly. At step 928, the user clicks on ticket representations on the graphical venue map and individual ticket offers are displayed. If the user is not satisfied at step 930, the user may return to step 928 to adjust selections. Otherwise, the user proceeds to step 932 and clicks on individual ticket offers. In step 934, detailed information regarding the ticket is displayed. If the user is not satisfied with this information in step 936, then the user may return to step 932 and select other ticket offers to view the status of those tickets. However, if the user is satisfied, the user may continue to step 938 and click the BUY button. This results in the user being redirected to the ticket seller's site at step 940, where the user buys the tickets at step 942.

I claim:

1. A method for representing an aggregated georeferenced search result set, comprising the steps of:
a) displaying a symbol that is proportional in size to the number of search results in said aggregated georeferenced search result set, said symbol superimposed on a map in a position that geographically corresponds to a position attribute of said aggregated georeferenced search result set, said symbol comprising at least two areas that are essentially proportional in size to the number of results that have a price attribute value within price ranges that correspond to said at least two areas;
b) enabling a user to dynamically modify parameters that define the limits of said price ranges through a price range modification mechanism;
c) updating said at least two areas as the user manipulates said price range modification mechanism.

2. The method of claim 1, further comprising a mechanism whereby a user can select said symbol to obtain details of the search results that are members of said aggregated georeferenced search result set.

3. The method of claim 1, wherein said at least two areas are two areas.

4. The method of claim 3, wherein said limits of said price ranges share a common value between the two price ranges corresponding to said two areas.

5. The method of claim 4, wherein said price range modification mechanism modifies said common value.

6. The method of claim 1, wherein said price range modification mechanism comprises a price range continuum.

7. The method of claim 1, wherein said price range modification mechanism is a slider.

8. The method of claim 1, wherein said map is a seating layout.

9. The method of claim 8, wherein said aggregated georeferenced search result set comprises seat availability data.

10. The method of claim 9, wherein said seat availability data comprises seat availabilities for multiple performances.

11. The method of claim 1, wherein said map is a geographic map.

12. The method of claim 11, wherein said aggregated georeferenced search result set comprises real estate data.

13. The method of claim 11, wherein said aggregated georeferenced search result set comprises hotel room availability data.
